(19) United States
(12) Patent Application Publication
(10) Pub. No.: US 2022/0379511 A1
(43) Pub. Date: Dec. 1, 2022

(54) CUTTING MACHINE FOR PRODUCTS MADE OF CELLULOSE MATERIAL AND RELATED METHOD

(71) Applicant: Korber Tissue S.p.A., Lucca (IT)

(72) Inventors: Ivano James GIROLAMI, Lucca (IT); Matteo FAVILLA, Lucca (IT)

(73) Assignee: Korber Tissue S.p.A., Lucca (IT)

(21) Appl. No.: 17/765,075

(22) PCT Filed: Oct. 1, 2020
(86) PCT No.: PCT/EP2020/077600

§ 371 Date: Mar. 30, 2022

(30) Foreign Application Priority Data
Oct. 3, 2019 (IT) 10 2019 000017801

(51) Int. Cl. B26D 1/18; B26D 3/08; B26D 3/16; B26D 5/00; B26D 5/32; B26D 7/12

(52) U.S. Cl. CPC B26D 1/18; B26D 3/08; B26D 3/16; B26D 5/007; B26D 5/32; B26D 7/12

(57) ABSTRACT

The machine includes a feed channel of a product to be cut and members for feeding the product along the feed channel. A cutting blade is provided to cut the products into articles according to cutting planes orthogonal to a longitudinal direction of the products and a sharpening unit is provided to sharpen the cutting blade. The machine further includes an adjustment system that receives in input at least one information on the operation of the cutting machine and provides, in response to the information, an adjustment command of the cutting machine.

### TECHNICAL FIELD

The present invention concerns improvements to cutting machines for cutting logs of wound material or, more generally, products made of cellulose material having a longitudinal dimension, into articles of smaller longitudinal dimension. The invention also concerns improvements to the methods for cutting these products. In particular, embodiments disclosed herein concern methods and cutting machines for cutting logs of cellulose web material, such as tissue paper, stacks of interfolded cellulose sheets or the like.

### BACKGROUND ART

In many industrial fields, for producing logs of wound web material or stacks of interfolded sheets, operations are carried out to produce logs or stacks of sheets with large axial dimensions, which are subsequently cut into smaller rolls or shorter stacks, i.e. rolls or stacks of smaller axial dimensions, intended for packaging and sale.

Typical examples of this type of operation are found in the field of tissue paper converting, for producing rolls of toilet paper, kitchen towel, napkins, wipes, paper towels and the like. In this field, plies of cellulose material are produced by paper machines and wound on parent reels. These are subsequently unwound and rewound in rewinding machines, to form logs, or in interleavers to form stacks of interfolded sheets, the axial length of which corresponds to the width of the ply produced by the paper machine and is equal to a multiple of the axial length of the products intended for trade.

Cutting machines are used to subsequently divide the logs into rolls with smaller axial dimensions, intended to be packaged and marketed. Examples of cutting machines of this type are disclosed in U.S. Pat. Nos. 6,786,808, 5,522,292, US 20120297944, US201900999909, WO2017186520, WO2019016665. Similar machines are used to cut the stacks of interfolded sheets.

The cutting machines for logs of wound web material, in particular tissue paper, typically comprise a forward movement or feed channel for feeding logs to be cut and a cutting head arranged along the forward movement path. Advancement of the logs is typically obtained by means of feed members, such as pusher members, which move the logs forward with an intermittent or continuous motion along the feed channels. The cutting head comprises one or more cutting blades provided with a forward movement with respect to the log to be cut and with a cutting movement. The cutting blades are in many cases disc blades that rotate about their axis (cutting motion) and that are, moreover, provided with a cyclical movement, for example a rotation or pivoting motion (forward movement). The pivoting or rotation motion is generally circular or elliptic. Through the cutting blade, the logs of larger axial dimension are divided into single rolls intended for packaging.

The cutting blades are subject to dulling and therefore require frequent sharpening. Sharpening of the cutting blade is carried out with a sharpening unit. This sharpening operation causes a gradual erosion of the cutting blade. In the case of disc-shaped cutting blades, this means a gradual decrease in the diameter of the cutting blade. When the minimum dimension of diameter is reached, the disc blade must be replaced.

Cutting machines have many moving members and related actuators. These members and actuators must be controlled and adjusted as a function of multiple pieces of information on the operation of the machine and as a function of operating parameters. The operating conditions affect the wear of the cutting blades. Some of the factors or parameters that affect operation of the cutting machine are parameters relating to the cutting machine itself. Other parameters or factors relate to the characteristics of the product to be cut, i.e. are information relating to the characteristics of the logs.

A correctly sharpened cutting blade is important to obtain proper operation of the machine and high quality end products (rolls). In fact, blades with a blunt cutting edge cut badly, generate stresses and localized overheating of the material to be cut and as well as compression forces that damage the end product, which can be permanently deformed, which compromise the quality thereof and can lead to the product being discarded. For example, the rolls or the stacks of sheets can be cut out of square, i.e., with the lateral side oblique and not perfectly perpendicular to the axis of the log or of the stack, or the edge of the cut can have imperfections, such as creases, grooves or scores on the paper.

In addition to being influenced by the sharpness of the cutting blade, cutting conditions can also be influenced by the dimension of the diameter of the disc-shaped cutting blade. In fact, this has a variable thickness, minimum at the periphery and maximum in the center. As the disc-shaped cutting blade becomes gradually worn, the thickness of the active part thereof, i.e. the part that penetrates the log to be cut, increases. This influences the cutting conditions. Moreover, repeated sharpening operations can alter the shape of the disc-shaped cutting blade, which tends to lose the circular shape of the cutting edge. This leads to defects in the product cut and generates vibrations or dynamic stresses on the cutting machine.

Sharpening causes wear of the cutting blade. Sharpening is carried out repeatedly over time, but not continuously. In other words, normally the cutting blade is not in contact with the grinding wheels of the sharpening unit. These operate intermittently, for short periods of time, when the blade has lost its cutting edge to the extent that is no longer acceptable for a high quality cut. During sharpening the cutting blade is consumed. Therefore, the duration of the cutting blade decreases in proportion to the increase in sharpening frequency and to the increase in the duration of each sharpening cycle, i.e. the increase of the time for which the grinding wheels remain in contact with the blade.

On the other hand, as noted above, proper sharpening of the cutting blade is required to obtain a high quality product.

Therefore, it is necessary to find the correct balance between the need for the cutting edge of the cutting blade to be kept sharp and the need to prevent premature wear of the cutting blade.

The adjustment of different operating parameters of the cutting machine is a critical operation that requires frequent action by the operator. The latter must be suitably skilled to be able to adjust the operating parameters of the cutting machine as a function of the various operating conditions, including various factors defining the type of product to be cut.

In fact, the logs of paper can have many variable parameters, such as the diameter, the hardness or compactness of the windings, the quantity of plies bonded or glued to one another and wound, the amount of glue used, whether or not a cardboard core is present, the grammage of the carboard of the core, the grammage of the paper plies, the number of strips of cardboard used to form the winding core, the diameter of the winding core, and yet others.

Cutting machines generally have a high productivity and, for certain products, can even exceed 250 strokes per minute. The limited time available for each single cut, the quality required of the cuts and the great variability of parameters involved mean that the machine must be subjected frequently to complex adjustments that require a skilled operator in order to be performed correctly.

### SUMMARY

According to an aspect, there is provided a cutting machine, comprising at least one feed channel of products to be cut transverse to their longitudinal extension, to obtain articles with smaller longitudinal dimension. In particular, the cutting machine can be adapted to cut stacks of folded interfolded sheets or logs of wound web material, in both cases typically made of plies of cellulose fibers. Members for feeding the products to be cut along the feed channel are associated therewith. The cutting machine further comprises at least one cutting blade adapted to cut the products into articles with smaller longitudinal dimensions, according to cutting planes orthogonal to the axis of the products, i.e. to the direction of longitudinal extension of the products. In the case of stacks of interfolded sheets, this direction is the direction in which the sheets are stacked. In the case of logs, the longitudinal direction is the direction of the winding axis of the logs. The machine further comprises a sharpening unit, adapted to sharpen the cutting blade, and an adjustment system. Characteristically, the adjustment system is adapted to: receive in input at least one piece of information on the operation of the cutting machine; and to provide, in response to said information, an adjustment command on the cutting machine.

Within the context of the present description and of the accompanying claims, an “adjustment command” provided by the adjustment system can be a signal applied directly or indirectly by the adjustment system to an element, component, member or part of the machine, or of an ancillary apparatus thereof, to carry out an action, such as modify an operating parameter and, more generally, trigger an event. In this case the adjustment command can automatically cause an action to be performed by the cutting machine or by a component belonging to the cutting machine or associated therewith. Moreover, the concept “adjustment command” also includes, in the present context, a signal communicating a parameter to be set, an action to be performed, or in general an event that must be performed on the or in the cutting machine, in a part or member thereof, or in its ancillary apparatus, without an automatic performance or implementation.

In the first case, the adjustment command can be a command that activates an event directly, without the action of an operator. In the second case, the adjustment command can be communicated to an operator by means of a human-machine interface. The operator will then perform the actions required for the event to take place on the machine or in the machine. In the second case, the adjustment action is mediated by the operator, who can decide whether to perform it, not perform it or to modify it with respect to the operation suggested by the adjustment system.

In entirely general terms, after receiving information “A” on the operation of the cutting machine, received by the adjustment system, the latter generates a adjustment command “B” of the cutting machine as a response. The adjustment command can be performed directly, automatically by the cutting machine. Alternatively, the adjustment command “B” is notified to the operator, who has the cutting machine perform it.

Hereinafter, reference will be made specifically to a cutting machine for cutting logs of wound web material, with or without a core, to produce rolls with smaller axial dimensions, through cuts according to planes orthogonal to the winding axis. However, as mentioned previously, the cutting machine can be used to cut other types of elongated products, such as stacks of interfolded sheets to obtain articles in the form of packs of interfolded sheets with smaller longitudinal dimensions.

In practice, the adjustment system can be configured to perform a learning or self-learning cycle, through which one or more adjustment signals correspond to specific pieces of information acquired by the cutting machine.

Within the present context, as will be more apparent below, the term “information on the operation of the machine” also comprises information relating to the product to be cut.

According to another aspect, disclosed herein is a method for cutting a log of web material, or more generally a longitudinally elongated product, typically a product consisting of sheets made of cellulose material, or a product consisting of a cellulose wound web material. The method provides for making cuts orthogonal to the longitudinal extension of the product to obtain, from each product, a plurality of articles with smaller longitudinal dimensions. The cut is performed by means of a cutting machine of the type defined above. The method comprises the following steps: feeding a product to be cut along the feed channel;

cyclically moving the cutting blade with respect to the product to be cut, said cutting blade having a forward movement and a cutting movement with respect to the product to be cut;

acquiring at least one piece of information on the operation of the cutting machine;

by means of the adjustment system, automatically generating an adjustment command on the cutting machine as a function of said at least one piece of information on the operation of the cutting machine.

Further advantageous features and embodiments of the method and of the machine according to the invention are described below and are defined in the appended claims, which form an integral part of the description.

### BRIEF DESCRIPTION OF THE DRAWINGS

The invention will be better understood following the description and the accompanying drawings, which illustrate a non limiting example of embodiment of the invention. More in particular, in the drawings:

FIG. 1 shows a schematic side view of a cutting machine and related adjustment and control system;

FIG. 2 shows an enlargement of the cutting head;

FIGS. 3A, 3B, 3C show schematic side views of a cut roll;

FIGS. 4A, 4B show schematic front views of a cut roll.

### DETAILED DESCRIPTION

The detailed description hereunder of exemplary embodiments refers to the accompanying drawings. The same reference numbers in different drawings identify the same or similar elements. Moreover, the drawings are not necessarily to scale. Moreover, the detailed description below does not limit the invention. Instead, the scope of the invention is defined by the appended claims.

The reference throughout the description to “an embodiment” or “the embodiment” or “some embodiments” means that a particular feature, structure or element described in relation to an embodiment is comprised in at least one embodiment of the subject described. Therefore, the phrase “in an embodiment” or “in the embodiment” or “in some embodiments” in various points of the description does not necessarily refer to the same embodiment or embodiments. Moreover, the particular features, structures or elements can be combined in any suitable manner in one or more embodiments.

A cutting machine for cutting logs of a cellulose wound web material, with or without winding core, coming from a rewinding machine is described in detail below. However, it must be understood that in other embodiments the cutting machine can be configured to cut stacks of interfolded sheets, for example coming from an interfolding machine.

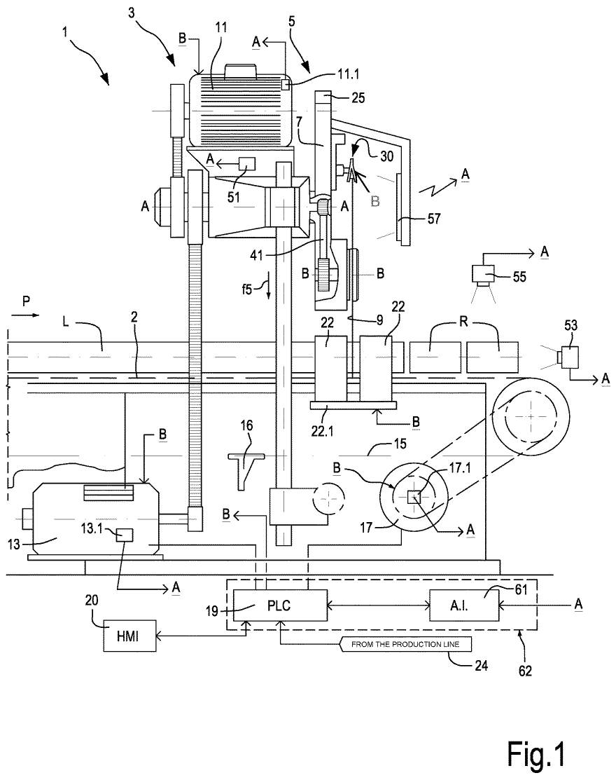

FIG. 1 schematically illustrates the main members of a cutting machine 1, in which the invention described herein can be incorporated. It must be understood that the structure of the cutting machine can differ from the one briefly described and illustrated herein. For example, the transmission members of the forward movement of the logs and of the disc-shaped cutting blade can differ. The disc-shaped cutting blade can have a reciprocating, for example pivoting, motion, instead of a continuous rotational motion as in the present embodiment, described in greater detail below. Moreover, the cutting head of the cutting machine can comprise more than one disc-shaped cutting blade. Non-discoidal cutting blades, for example bandsaw blades, could also be used. These latter may be particularly indicated for cutting logs of wound web material, with a very large diameter and high compactness, such as industrial logs.

The cutting machine 1 illustrated herein comprises a feed path schematically indicated with P, implemented by one or more feed channels 2, along which logs L are fed in order to be cut to form rolls R, with an axial dimension smaller than the logs L. The rolls R are then fed to packaging machines, not shown. The cutting machine 1 is positioned downstream of a rewinder and of other processing stations, not shown and known to those skilled in the art, for example tail sealers, storage units and the like.

In some embodiments, the cutting machine 1 comprises a cutting station 3, which in turn comprises a cutting head, indicated schematically with 5. The cutting head 5 can comprise mobile unit 7 carrying one or more disc-shaped cutting blades. The mobile unit 7 is provided with a cyclical movement, for example a rotation movement about the rotation axis A-A, which can generally be roughly orientated in the direction of the feed path P of the logs L to be cut along the feed channel 2. As specified above, in other embodiments the mobile unit 7 can be provided with a reciprocating movement, for example a reciprocating rotation movement, or a roto-translation movement.

In the illustrated example, the mobile unit 7 of the cutting head 5 supports a disc-shaped cutting blade 9, rotating about the rotation axis B-B thereof. The rotation axis B-B of the disc-shaped cutting blade 9 can generally be oriented roughly in the direction of the axis A-A. As is known to those skilled in the art, there are cutting machines in which the axes A-A and B-B are not perfectly parallel to each other and/or to the direction of feed along the feed path P of the logs to be cut. This is due to various characteristics of the cutting machine that are not of interest in the present description and that concern the relative movements between the cutting head 5 and the forward movement of the logs L to be cut.

The cutting machine 1 can comprise a motor, typically an electric motor 11, which supplies the rotation motion to the disc-shaped cutting blade 9 about the axis B-B. The cutting machine 1 also comprises a further motor, typically an electric motor 13, which supplies the rotation movement of the cutting head 5 and in particular the cyclical motion of the mobile unit 7 about the axis A-A.

Feed of the logs L along the feed channel or channels 2 according to the path P can be obtained by means of an endless flexible member 15, such as a chain or a belt, which can be driven by a motor, typically an electric motor 17. The flexible member 15 can comprise pushers 16 arranged preferably at regular intervals along the extension of the flexible member 15 to push each single log L along the feed channel through the cutting station 3.

Advantageously, the motors 11, 13 and 17 can be controlled by a central control unit 19, such as a PLC, a microcomputer, a PC or the like. The central control unit 19 can be a central control unit that only manages the cutting machine 1, although it would also be possible for said central control unit 19 to be interfaced with other stations, machines or devices of the converting line, whereof the cutting machine 1 is part. The letter “B” indicates a generic connection of the central control unit 19 with a plurality of actuators of the cutting machine 1.

In some embodiments, the forward movement of the logs L can be intermittent. During dwell periods, the log L is cut by the disc-shaped cutting blade 9. In other embodiments, feed can be continuous, at constant or variable speed. In this case, the mobile unit 7 and/or the disc-shaped cutting blade 9 can be provided with a back-and-forth movement along the path P to cut the log L while the latter moves forward along the feed path P without stopping.

In some embodiments, side retaining elements can be provided to retain the log L during cutting. The retaining elements can be provided with an opening and closing movement. In this case the retaining elements closed during the cut to hold the log L still, ensuring a higher quality cut, and open again when the log L must move forward. In FIG. 1 the retaining members are represented schematically and indicated with 22. Preferably, there are two retaining elements: one upstream of the cutting plane, to block the log L, and one downstream of the cutting plane to retain the part of log L that is separated from the log to form a roll R. An actuation system for operating the retaining members 22 is indicated with 22.1.

The central control unit 19 can be directly or indirectly connected to a human-machine interface (HMI) indicated with 20, to receive data, information or commands entered by an operator via the interface 20 and/or to communicate data, information, alarm notifications, adjustment commands or the like to the operator. The interface 20 can comprise a monitor and human-machine interaction devices for entering data or commands, such as a keypad, a mouse, a touch-pad, a joy-stick, or a combination thereof, or of other known devices. The interface 20 can comprise, or be in communication with a mobile device, such as a smartphone or a tablet, or eyewear or other suitable devices for augmented reality, with which the operator is equipped.

Moreover, the central control unit 19 can be in communication with a control unit of higher level and/or with one or more control units of the same level, associated with other machines of a production line of which the cutting machine 1 is part. The production line and the respective control units, and any units of higher level, such as a computer for monitoring the production line, are not shown.

FIG. 1 schematically indicates a data connection 24 with one or more control units interfaced or associated with the converting line in which the cutting machine 1 is inserted. The connection 24 can provide data, parameters or information in general, for example on the features of the product to be cut, i.e., of the logs L fed from the rewinder upstream, which must be divided into rolls R by the cutting machine 1.

In particular, in some embodiments the central control unit 19 can be provided with one or more of the following data: length of web material wound in the logs L;

diameter of the logs; number of cellulose plies of which the web material is composed; information on the cellulose material forming the web material and on any additives, such as wet-strength resins; grammage of the web material; type of processing of the web material, for example the presence or absence of embossing, printing, gluing; weight of the logs L; winding density or winding compactness of the logs L, which can be defined, for example, based on a ratio between length of wound web material and diameter of the logs; presence of a winding core in the logs L; data on the composition of the winding core; etc. The data relating to the composition of the winding core can, for example, concern the material of which it is composed, typically cardboard, but alternatively plastic or the like. These data can also concern the consistency, i.e. the thickness and/or the mechanical strength of the winding core, or its hardness or shear strength. Data on the consistency of the winding core can concern the number of helically wound strips that form the tubular core, typically helically wound and glued cardboard strips. The consistency data of the winding core can also concern the grammage, the thickness or other physical characteristics of the material of which the winding core is composed. Further data can concern the diameter of the winding core.

In the present context the data relating to the product (log L) to be cut in the broad sense form information on the operation of the cutting machine 1. In fact, they determine the behavior of the cutting machine and/or can influence the operation thereof. Typically, the features of the logs L, of the web material of which they are formed, of the material of which the winding cores (if present) are formed, influence the mechanical stresses to which moving members, in particular the disc-shaped cutting blade 9, are subjected. These characteristics typically also influence wear of the disc-shaped cutting blade 9 and can contribute to determining the frequency with which the disc-shaped cutting blade 9 must be sharpened and/or the time for which it must be sharpened.

Data relating to the product (log L) to be cut can also influence the compression stresses generated between the disc-shaped cutting blade and the cellulose material, of which the logs L are formed. Wound logs L with greater density, for example, offer greater resistance to the penetration of the disc-shaped cutting blade 9. This can also be relevant in determining the minimum dimension that the disc-shaped cutting blade 9 can reach before it requires to be replaced.

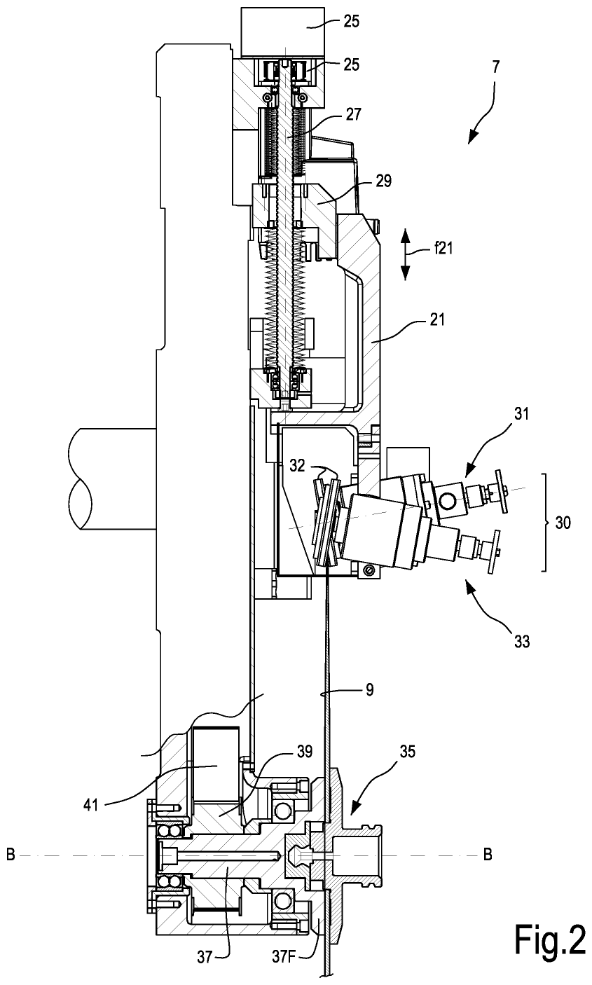

FIG. 2 illustrates a possible embodiment of the cutting head 5 and more in particular of the mobile unit 7. In this embodiment, the cutting head 5 comprises a slide 21 mounted on the mobile unit 7 so as to be able to move according to the double arrow f21 for the purposes that will be explained below. A gear motor, indicated schematically with 25, provides the slide 21 with the movement according to the double arrow f21. Transmission of the movement can be obtained through a threaded bar 27 and nut screw 29 system, for example with a recirculating ball screw. The nut screw 29 can be constrained to the slide 21.

A sharpening unit, indicated as a whole with 30, is arranged on the slide 21 to sharpen the disc-shaped cutting blade 9 when required. The sharpening unit 30 can comprise two sharpening units indicated with 31 and 33. Each sharpening unit 31, 33 comprises a respective grinding wheel 32. The grinding wheels 32 are arranged such that each wheel sharpens one of the two sides of a cutting edge of the disc-shaped cutting blade 9.

The grinding wheels can be provided with a sensor adapted to detect the contact pressure with the disc-shaped cutting blade 9. This sensor can have a dual purpose. The first to detect the contact position of the grinding wheels on a disc-shaped cutting blade 9 that has just been installed. In fact, each time a new disc-shaped cutting blade 9 is installed on the machine, it is necessary to know the relative distance between sharpening unit and cutting edge of the cutting blade to be able to subsequently move the sharpening unit 30 forward by an amount suitable to carry out the sharpening cycles correctly. The second to measure the contact force of the grinding wheel on the disc-shaped cutting blade 9. In fact, excessive force can damage the disc-shaped cutting blade 9 and can also cause incorrect sharpening; it undoubtedly causes excessive wear of the cutting blade.

Moreover, the mobile unit 7 comprises a coupling, indicated as a whole with 35, for the disc-shaped cutting blade 9. The coupling 35 can comprise a rotating spindle or shaft 37 rotated by means of a toothed wheel or a toothed pulley 39, about which a toothed belt 41, which takes its motion from the motor 11, can be driven (FIG. 1).

During normal operation of the cutting machine 1, the sharpening unit 30 is in the inactive position. In this position, the grinding wheels 32 are not in contact with the disc-shaped cutting blade 9. This idle condition can be obtained by keeping the slide 21 spaced radially from the rotation axis B-B of the disc-shaped cutting blade 9. When a sharpening cycle of the disc-shaped cutting blade 9 is required, the gear motor 25 controls a radial movement of the slide 21, and hence of the sharpening unit 30 carried thereon, according to the arrow f21 toward the cutting edge of the disc-shaped cutting blade 9. In this way, the grinding wheels 32 are brought into contact with the two sides of the cutting edge of the disc-shaped cutting blade 9. Contact is maintained for a suitable interval of sharpening time, which can be adjusted in the manner explained in greater detail below. At the end of the sharpening cycle, the gear motor 25 moves the slide 21 away from the disc-shaped cutting blade 9 once again with a movement according to the arrow f21.

Characteristically, the cutting machine 1 can be equipped with a plurality of elements for the acquisition of information concerning the operation of the cutting machine. Said elements for the acquisition of information can firstly comprise transducers or sensors adapted to detect electrical parameters of one or more of the electric motors with which the cutting machine 1 is provided. In particular, in the diagram of FIG. 1, reference number 11.1 indicates a sensor device for detecting at least one electrical parameter of the motor 11, reference number 13.1 indicates a sensor device for detecting at least one electrical parameter of the motor 13 and reference number 17.1 indicates a sensor device for detecting at least one electrical parameter of the motor 17. One or more of the sensor devices 11.1, 13.1 and 17.1 can detect one or more parameters correlated, for example, to the power absorbed by the respective motor. In particular, each sensor device can detect the absorbed current. In some embodiments, one or more of the sensor devices may be capable of detecting the delivered torque. In some configurations, the electrical parameters of the motors are detected directly by the drives that supply the motors; the drives are located in usual electrical panels, not shown for simplicity. In this case, the drives also act as sensor devices for the acquisition of the electrical parameters of interest.

The cutting machine 1 can further comprise one or more vibration detection devices for detecting the vibrations of one or more members of the cutting machine 1, for example of the load bearing structure, or of the mobile unit 7. In some embodiments, instead of or in addition to a vibration detection device for detecting mechanical vibrations, a vibration detection device for detecting acoustic vibrations generated by the members of the cutting machine, such as a microphone, can be provided. The vibration detection device (mechanical of the structure and/or acoustic vibrations) can, for example, detect vibrations that are abnormal or with increasing intensity, generated by the rotation of the disc-shaped cutting blade 9, the balance of which can deteriorate as a function of its wear. It is also possible to detect abnormal impact forces between the disc-shaped cutting blade 9 and the logs L as a function of the wear of the disc-shaped cutting blade 9 or of the need to sharpen it.

Purely by way of example, in FIG. 1 reference number 51 indicates a generic vibration detection device for detecting mechanical and/or acoustic vibrations. Although this figure indicates a single element for detecting acoustic or mechanical vibrations, attached to the load bearing structure of the cutting head 5, it must be understood that there could be several detection devices, even of different kinds, arranged in different positions of the cutting machine 1, for example directly on the mobile unit 7, or around the cutting machine 1. When the detection device is on the mobile unit 7, the data provided thereby can be transmitted through a wireless connection, for example with a Bluetooth, wi-fi or other radio system.

In some embodiments, two or more acoustic detection devices can be provided. One or a plurality of acoustic detection devices closer to the cutting zone of the logs L are used, for example, to record with greater precision the sound wave generated during cutting; one or a plurality of acoustic detection devices closer to the grinding wheels 32 can be used to record with greater precision the sound wave generated during the sharpening step of the disc-shaped cutting blade 9.

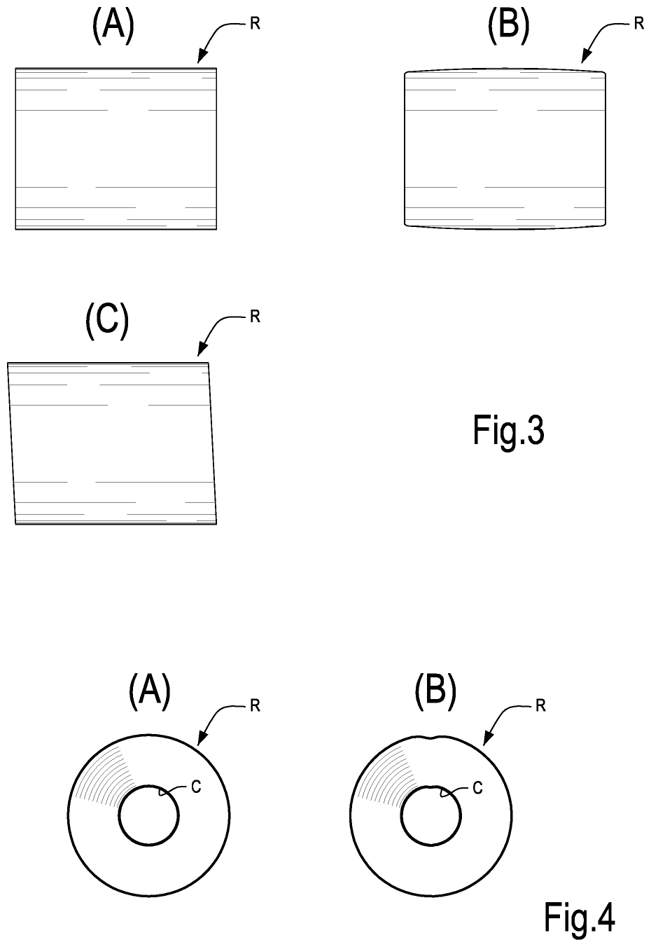

The information acquisition elements can also comprise one or more video cameras, for acquiring images of the rolls R obtained by cutting the logs L. These images allow checking the quality of the product obtained by the cut. FIG. 1 schematically indicates two video cameras 53 and 55, arranged to respectively record a side image and a front image of the rolls R obtained by cutting the logs L. The position of the video cameras 53, 55 is purely indicative. They can also be placed at a distance with respect to the cutting head of the cutting machine 1. FIGS. 3A, 3B and 3C schematically represent side images of a roll R. More in particular, FIG. 3A indicates a side view of a correctly cut roll R , while FIG. 3B indicates a side view of a roll of substandard quality, deformed at the ends. FIG. 3C shows a roll with cut surfaces that are out of square. FIGS. 4A, 4B schematically illustrate front views of a roll R with a winding core C. FIG. 4A shows a correctly cut roll R , while FIG. 4B shows a roll with deformations of the wound material and of the winding core C as a result of a poor quality cut, for example due to insufficient sharpening of the disc-shaped cutting blade 9.

In some embodiments, the cutting machine 1 can be equipped with a temperature detection device for detecting the temperature of the disc-shaped cutting blade 9. In the diagram of FIG. 1, the temperature detection device is indicated with 57 and is arranged on the mobile unit 7. It is therefore stationary with respect to the rotation axis B-B of the disc-shaped cutting blade 9. In some embodiments, the temperature detection device 57 can comprise a pyrometer or a plurality of pyrometers. In other embodiments, the temperature detection device can comprise a thermographic camera or a plurality of thermographic cameras. In yet further embodiments, combinations of temperature detection devices of different kinds, such as thermographic cameras and pyrometers, can be provided.

In general, the temperature detection device is a contactless device adapted to detect the temperature of the disc-shaped cutting blade 9. Preferably, as indicated schematically in FIG. 1, the temperature detection device is installed on the mobile unit 7, although this is not mandatory. In other embodiments, it can be installed in a fixed position. When the temperature detection device is installed on the mobile unit 7, the data detected can be transmitted through a rotary joint or through a wireless system, for example a wi-fi or Bluetooth system.

In some embodiments, the temperature detection device can comprise a thermographic camera that takes frames, each containing a complete image of the disc-shaped cutting blade 9. In other embodiments, the temperature detection device can acquire data relating to a portion, for example a segment, of the disc-shaped cutting blade 9. Data acquired in sequence can be correlated, for example through an encoder, to the angular position of the disc-shaped cutting blade 9, to reconstruct a temperature profile of the entire disc-shaped cutting blade 9.

The temperature of the disc-shaped cutting blade 9 can be used as indicator of the operating conditions of the blade. Higher temperatures indicate greater friction between disc-shaped cutting blade 9 and log L, symptom of incorrect operation of the cutting machine and, for example, of the need to perform a sharpening cycle of the cutting blade or replace it. Alternatively, high temperatures can also indicate a productivity that is too high for the type of product being processed. For example, very compact logs cut at a frequency that is too high can cause the disc-shaped cutting blade 9 to overheat, thus accelerating wear and decreasing the useful life thereof, with a negative impact on the quality of the cut. Therefore, in this case, an excessive temperature of the disc-shaped cutting blade 9 can indicate that the operating speed should be reduced for that type of compact log, in order to prevent overheating of the blade.

In general, some operating conditions that can be detected with one or more of the detection devices described above can be indicative of incorrect operation of the cutting machine 1 and can require an adjustment operation. To this end, one or more and preferably all the detection devices described are connected to an automatic adjustment system, schematically indicated with 61 in the diagram of FIG. 1. The adjustment system 61 can be implemented with any software and hardware system capable of acquiring information on the operation of the cutting machine 1 and of providing, in response to this information, an adjustment command on the cutting machine 1 in order to optimize the operation thereof. In the diagram of FIG. 1, the adjustment system is represented as a block that is separated from the central control unit 19 and connected thereto. However, this configuration is not binding. For example, the central control unit 19 and the adjustment system 61 can be integrated in a single digital system, as schematically indicated with 62 in FIG. 1.

Data coming from the devices associated with the cutting machine can be acquired by the adjustment system 61, or by the central control unit 19 and can be exchanged between the two blocks 19 and 61. Alternatively, if a single digital system 62 is provided, this can receive the data from the devices associated with the cutting machine. Likewise, the adjustment commands can be sent by the adjustment system 61 to the central control unit 19 and by this to the single devices, servomechanisms, actuators and other components associated with the cutting machine, or can be sent directly to these latter by the adjustment system 61. If a single block containing all the functions of the central control unit 19 and of the adjustment system 61 is provided, this single block can send the adjustment signals to the devices of the cutting machine. Likewise, instead of being connected to the central control unit 19 as represented in FIG. 1, the interface 20 can be connected to the adjustment system 61, or to a single block that contains the functions of the blocks 19 and 61.

In general, the software and hardware configuration for controlling and adjusting the cutting machine can vary as a function of the technology available time by time, of the manufacturer's design choices and also of any need to integrate new adjustment functions into an existing cutting machine already provided with a central control unit.

In the diagram of FIG. 1, the connection between the adjustment system 61 and the single detection devices is represented with an arrow accompanied by the letter “A”. In the illustrated example the adjustment system 61 is connected with the sensor devices 11.1, 13.1 and 17.1, to receive information on one or more electrical parameters of the motors 11, 13 and 17. Moreover, the adjustment system 61 is connected with the video cameras 53 and 55, to receive information on the shape of the rolls R obtained by cutting the logs L. The adjustment system 61 is also provided with information relating to the acoustic or mechanical vibrations detected by the detection device 51, and information relating to the temperature of the disc-shaped cutting blade 7 through the thermographic camera or other temperature detection device 57.

Moreover, the adjustment system 61 can receive information coming from the production line and information coming from the human-machine interface 20.

In some embodiments, the adjustment system 61 is a neural network system, which can be created with a self-learning process, or with an operator learning process, or with a combination of these processes (machine learning). In general, as a result of a self-learning process and/or of operator learning, the adjustment system 61 becomes able to generate adjustment commands in response to incoming information, in order to optimize the operation of the cutting machine 1 and/or to determine the maximum speed as a function of the product being processed, i.e., determine the maximum speed corresponding to the desired quality of the cuts made on the logs L.

An operator learning step can be carried out simply by operating the cutting machine 1 in a conventional manner, where the operator takes action to correct the operation of the cutting machine 1 in the presence of abnormal situations, for example defects in the end product (rolls R), excessive wear of the cutting blade 9, abnormal vibrations or the like.

Unlike in prior art machines, in the present case, in a learning step the operator's actions are acquired by the adjustment system 61 together with information coming from the sensor and detection devices, so that the adjustment system 61 “learns” what types of action must be carried out in the presence of given information coming from the cutting machine 1. Learning is in this case dependent on the operator's skill. In other words, the adjustment system acquires, stores, correlates and processes the parameters of the cutting machine 1 with the information coming from the sensor devices and with the adjustment actions taken by the operator.

It is possible to perform a learning step on one or more operating cutting machines to create a trained adjustment system. This can be installed on other similar or identical cutting machines, which will be able to operate automatically without the need for a further learning cycle, or with a shorter learning cycle.

Instead of a learning step as described above, the adjustment system 61 can be configured through a self-learning step. In this case, the adjustment system 61 acquires information on the operation of the cutting machine 1 and, when anomalies occur, performs adjustment actions, recording the result. With an iterative series of adjustments, the adjustment system self-learns which adjustment commands must be imparted to the cutting machine 1 to optimize the operation thereof

It would also be possible to use mixed learning techniques, for example in which the adjustment system is partially trained by an operator learning cycle and subsequently, or in parallel, also performs self-learning activities.

In general, the adjustment system 61 generates an adjustment command or signal that can be applied directly, or through the central control unit 19, to the member or members to be adjusted, to give rise to an event in the cutting machine or in an ancillary device thereof. However, this is not the only possible method of operation. As will be clarified below, the adjustment system 61 can be configured to provide adjustment signals or commands that are then performed in a manner mediated by the operator.

Some possible operating situations that require adjustment actions by the adjustment system 61 will be described below.

The production of rolls with a cut that is out of square (FIG. 3C) can be indicative of incorrect retaining of the logs L during cutting. The adjustment system can in this case impart an adjustment command to the actuation system 22.1 of the retaining members 22. Alternatively, or in combination, to obtain an improved cut, the adjustment system 61 can impart an adjustment command to the rotational motor 11 of the disc-shaped cutting blade 9 in order to increase the rotation speed, i.e., the cutting speed. Alternatively, or in combination, the rotation of the mobile unit 7 about the axis A-A can be reduced, which causes a reduction of the speed of forward movement of the disc-shaped cutting blade 9 through the material to be cut. In this latter case, by decreasing the strokes per minute of the cutting machine 1, the time for intermittent feed of the logs L increases, subjecting them to milder dynamics. For example, the forward movement and braking accelerations of the logs L decrease, improving positioning of these latter and giving the retaining members 22 more time to clamp the logs L.

A plurality of operating conditions can require adjustment actions on the sharpening unit.

If the vibration detection device 51 detects an increase in the noise or in the vibrations at each cut of the log L, this can be indicative of the need to perform a sharpening cycle. The adjustment system 61 can thus provide a sharpening command and/or adjust the frequency with which sharpening cycles are performed, so that sharpening is performed before an increase in the noise or in the vibrations occurs. The adjustment command in this case acts on the gear motor 25.

As mentioned above, as the disc-shaped cutting blades 9 have a biconical shape, i.e., the two opposite faces have the shape of a cone with a wide angle at the vertex, the thickness of the disc-shaped cutting blade 9 increases from the periphery toward the center. As a result of repeated sharpening cycles, the diameter of the disc-shaped cutting blade 9 decreases. The cutting head 5 is therefore gradually moved toward the feed channel 2 (arrow f5 in FIG. 1) to offset the reduction in diameter of the disc-shaped cutting blade 9. This causes an increase in the thickness of the active part of the blade, i.e., of the portion of blade that interacts with the log L during the cut.

As the thickness of the disc-shaped cutting blade 9 increases, this causes an increase of the friction between the disc-shaped cutting blade 9 and the material to be cut. Such increase causes an increase in the power required by the motor 11 to rotate the disc-shaped cutting blade 9. The adjustment system 61 receives in input information from the sensor device 11.1 or from the drive of the motor 11 and is therefore able to verify whether the increase in power required to cut the logs exceeds a limit, beyond which the diameter of the disc-shaped cutting blade 9 has become too small and the blade must be replaced.

When this occurs, the adjustment system 61 can send an alert to the operator, for example through the interface 20. It would also be possible to connect the adjustment system 61 and/or the central control unit 19 to a mobile device, such as a smartphone or a tablet, with which the operator is provided, through which the operator is notified of the need to change the disc-shaped cutting blade 9.

The need to replace the disc-shaped cutting blade 9 can also be indicated, for example, by an anomalous value of the temperatures detected by the temperature detection device 57. This is due to the fact that an increase in friction between blade and log causes an increase in the heat generated during the cut.

In some cases, to overcome the increase in friction resulting from the reduction in the diameter of the disc-shaped cutting blade 9, before replacing it, the adjustment system 61 can impart a command to the motor 17 to move the pusher member 16 back before performing the cut. This backward movement allows the portion of log L upstream of the cutting plane to move back slightly under the thrust of the disc-shaped cutting blade 9. In this way, the pressure exerted by the disc-shaped cutting blade 9 on the material of the log L is reduced and as a consequence the friction is also reduced.

In some embodiments, the cutting machine 1 can be equipped with a magazine of disc-shaped cutting blades 9 and can be programmed to perform an automatic change of the disc-shaped cutting blade 9, for example as described in

US20190099909 and in other patent publications in the same family. In this case, the adjustment system can issue an adjustment command that causes the start of an automatic replacement cycle of the disc-shaped cutting blade 9.

The detection of noise or vibrations by the detection device 51 allows the adjustment system 61 to also carry out other adjustment actions, for example when the information on the operation of the cutting machine 1 is indicative of insufficient sharpness. Insufficient sharpness typically results in an increase in noise or in mechanical vibrations when the disc-shaped cutting blade 9 impacts against the log L to be cut. When, through the detection device 51, the adjustment system 61 detects a situation of this type, it can generate an adjustment command that increases the sharpening time, i.e., the time during which the sharpening unit 30 acts with the grinding wheels 32 on the cutting edge of the disc-shaped cutting blade 9.

The noise or vibration signal detected by the detection device 51 can be processed by the adjustment system 61, analyzing the response in frequency and/or using other existing signal analysis methods as a function of the state of the machine.

In some embodiments, for example, a Fourier transform is performed to discover the main frequencies that form the signal in relation to a precise operating mode of the cutting machine 1. The cutting machine 1 has a series of machine states that identify precise operating modes. For example, the machine can be in one of the following states:
“Emergency”, a condition in which the power to all the motors is cut off,
“Run”, the machine is running and cutting logs L normally,
“Stop” the machine is stopped but ready to “Run”.

Clearly, the most interesting state is “Run” in which it is also possible to identify a substate corresponding to the sharpening step of the cutting blade 9 that takes place without interrupting cutting of the logs L. For example, in the “Run” state, during the impact with the logs L a signal amplitude peak will be detected. The peak occurs with roughly the same frequency as that of the strokes per minute of the machine, i.e., of its productivity at that moment. Likewise, a noise with amplitude and frequency linked to the contact force between the disc-shaped cutting blade 9 and the sharpening unit 30, will be recorded during sharpening. Each variation of any operating parameter, or the variation of an operating condition, such as progressive wear of the disc-shaped cutting blade 9, causes a change in the signal detected, the anomaly or difference of which with respect to what was learned by the adjustment system 61 can generate either an alarm or an automatic adjustment adapted to restore the detected signals to conditions that correspond to an optimal adjustment of the cutting machine 1.

In another case, through frequency analysis and analysis of the amplitude of the vibration and/or noise signal, possibly correlating the data coming from the video cameras and from the temperature detection device 57, it is possible to detect whether, following a sharpening cycle, the cutting impact with the logs L produces high absolute value signals, the temperature remains higher than normal and/or the quality of the cut deteriorates. As explained previously, an increase in temperature is linked to an increase of the thickness of the disc-shaped cutting blade 9 as a result of its gradual wear. The adjustment system 61 can in this case request or give rise to replacement of the disc-shaped cutting blade 9.

In another case, once again due to the wear that can cause deformations of the disc-shaped cutting blade 9, it is possible to detect increasing vibrations on the cutting head 5, which do not decrease after a sharpening cycle. A cutting blade 9 that is deformed or is starting to become deformed also causes imperfect cuts on the logs detected by the video cameras 53 and 55. In particular, the video cameras can extract a geometrical profile of the deformed log R, i.e., that differs by more than a given amount from the theoretical profile of the outer diameter of the log R and/or of the diameter of the core, or that has cuts with sides that are out of square or irregular. The signals of motor current absorption also indicate malfunctions. In fact, it is possible to correlate fluctuations in the value of the current absorbed by the motors 11 and 13 primarily to the vibrations and/or to the noises detected by the sensor device 51 and secondarily to the data detected by the video cameras 53 and 55 and by the temperature detection device 57.

Ultimately, for each machine state, it is possible to replicate a data “cloud” populated by the various sensors, including the detection devices cited and the video cameras, the data of which correspond to correct operation. The deviation or the movement trend of at least one of said data indicates that the operating conditions have changed or are changing. As long as the data fall within a given correct operating space, the adjustment system 61 does not take action but monitors the cutting machine 1. In practice, as long as the data move in the direction that identifies correct and progressive wear of the blade, the adjustment system 61 does not perform any adjustment. Vice versa, if a parameter starts to deviate significantly from normal values, the adjustment system 61 takes action, restoring correct operation or giving rise to replacement of the cutting blade 9.

For example, if sharpening produces a limited vibration or a faded noise, together with a weak grinding wheel-cutting blade contact force signal, this means that wear of the cutting blade is such as to require a movement of the slide 21 toward the rotation axis B-B, so as to restore correct sharpening.

The case in which, following a sharpening cycle, the profiles of the logs R detected by the video cameras 53 and 55 is outside the standard is even more significant. In this case the adjustment system can increase the sharpening time, i.e., the grinding wheel-cutting blade contact time and in general can perform the operations that would be carried out by a skilled operator to restore a correct cut.

In the examples mentioned above, reference has been made to an action of the adjustment system on the cutting machine 1 or parts, devices or accessories thereof. In this way, the adjustment is carried out automatically.

However, as mentioned, this is not the only operating mode possible. In fact, in alternative, after having calculated and processed the best operating parameters of the cutting machine 1 as a function of the information detected by at least one sensor, the adjustment system 61 can communicate these parameters to an operator, generating an alarm or simply by means of a notification on the HMI 20 panel, or on a mobile device with which the operator is provided and linked via radio with the adjustment system 61 or with the central control unit 19. In this case, the operator can modify the operating parameters of the cutting machine manually, entering those calculated by the adjustment system 61. In practice, in this case the adjustment command or commands consist of signals, parameters, instructions or the like, which the adjustment system 61 transmits to the operator, so that this latter can carry out the actual adjustment.

Therefore, in this case the adjustment is not obtained directly and immediately, hence automatically, by means of the adjustment system 61 that acts on the cutting machine 1 or parts thereof, but in mediated mode. The operator carries out the adjustment “suggested” by the adjustment system 61. However, notification to the operator by the adjustment system 61 forms a “adjustment command”, in the meaning attributed to this term herein.

This operating mode mediated by the operator can be preferred, for example, in the period of time in which the adjustment system 61 is not yet perfectly calibrated and configured for optimal calculation of the operating parameters, i.e. for example during a learning step.

In fact, as is known, all artificial intelligence algorithms such as machine-learning or neural networks need time in which they “learn” from the skilled operator or “self-learn”, adapting to the operating modes and evolving until they can calculate the best parameters. Therefore, the cutting machine 1 can operate in automatic or semi-automatic mode, i.e. calculating and suggesting the best operating parameters through the interface 20 but giving the operator the possibility to modify these parameters, i.e.

to ultimately implement the adjustment commands on the machine.

In some embodiments, or in some operating steps, it would also be possible to combine the two different modes of performing the adjustment commands. Some can be executed automatically, without the action of the operator, others can be executed in mediated mode, through the action of the operator. In general, the type of adjustment, direct and automatic or mediated by the operator, can change over time, in the sense that some types of adjustment initially performed in mediated mode can later be performed directly and automatically, or vice versa. The first case can, for example, occur when a given type of adjustment requires a longer learning period than others. The second case can, for example, occur if the operator detects that an automatic adjustment performed by the adjustment system 61 does not give rise to the desired correction and therefore deems that subsequent adjustment commands must be examined and mediated by the operator, rather than performed directly and automatically.

When the commands are performed in a manner mediated by the operator, the operator can perform the command as identified and suggested by the adjustment system 61. Alternatively, for example if the operator deems that the command suggested by the adjustment system 61 is not suitable, he can perform it differently, for example imparting a greater or smaller variation than the one established by the command generated by the adjustment system. Alternatively, or in addition, the operator can decide to combine a second adjustment action, differing from the one suggested by the adjustment system 61. This can be done if the operator deems that the command generated by the adjustment system 61 is unsuitable.

In all cases, the adjustment system 61 can advantageously acquire information on the adjustment commands actually performed by the operator and record them, in order to continue learning, with the aim of improving the adjustment algorithms.

The adjustment actions determined by the adjustment system 61 can be aimed at improving the characteristics of the rolls R obtained by the cut through adjustment of the sharpening operations. The sharper and more efficient the disc-shaped cutting blade 9 is, the higher the quality of the cut rolls will be. A greater degree of sharpening is generally obtained by increasing the frequency of the sharpening cycles and the time of each sharpening operation. Moreover, more frequent replacement of the disc-shaped cutting blades 9 improves the quality of the cut product, as use of the portion of blade with greater thickness is avoided.

Nonetheless, these actions, which on the one hand improve the quality of the end product, have the drawback of reducing the useful life of the disc-shaped cutting blade 9, which is a particularly costly consumable component. Moreover, the replacement thereof requires the cutting machine 1 to be shut down, with the possible need to slow down the whole line and consequently leading to loss of production.

Therefore, in some cases, instead of optimizing the quality of the product, the useful life of the disc-shaped cutting blade 9 must be optimized to the detriment of the quality of the cut rolls R. In general, adjustment of the sharpening operations derives from a compromise between the need to reduce the running costs of the cutting machine 1 and to improve the quality of the rolls. Normally, for higher quality products, which can therefore be sold at a higher price, preference can be given to the quality of the product over the useful life of the disc-shaped cutting blade 9 and consequently to the detriment of the operating cost, which can be covered by a greater profit from the sale of the product.

The adjustment system 61 can be configured so that it is possible to set several adjustment modes of the cutting machine 1, selected from a mode that optimizes the quality of the cut, without limits in terms of useful life of the disc-shaped cutting blade 9, a mode that optimizes the useful life of the disc-shaped cutting blade 9 without taking account of the quality of the cut logs R, and a mode that optimizes the energy consumption of the cutting machine 1.

Similar considerations can be made in relation to other adjustment modes. For example, higher qualities of the cut product are generally obtained at lower productivity. It has already been noted, for example, that in some cases excessive deformation of the rolls obtained from the cut can be remedied by reducing the cut frequency, reducing the feed speed of the logs L, reducing the rotation speed of the mobile unit 7 about the rotation axis A-A. These adjustment actions lead to a reduction in productivity.

It is therefore possible for the adjustment system to be programmable also in this case for actions that give preference to one or other of the two contradictory requirements: maximum productivity; maximum quality of the end product. In this case, it is also possible to set an adjustment that gives priority to one or other of these two requirements, selectively giving greater importance to productivity, to the detriment of the quality of the end product, or greater importance to quality, to the detriment of productivity.

Therefore, in general, the adjustment system 61 can be configured to allow a selective setting between two or more operating modes. The adjustment system will in this case be adapted to be set selectively to generate an adjustment command as a function of said at least one piece of information and of an adjustment mode selectable to give preference to one or other of at least two different operating requirements.

These selections between different operating modes of the adjustment system can be obtained, for example, by setting more or less strict intervals of tolerance for different operating parameters of the machine. For example, to give priority to the useful life of the cutting blade with respect to the quality of the product, it is possible to set the adjustment system 61 so that it considers acceptable a certain level of deformation of the rolls, greater than the level considered acceptable in the case in which the adjustment gives priority to quality.

The aforesaid information provided to the adjustment system 61, additional with respect to the operating parameters of the single components of the cutting machine, for example the information relating to the characteristics of the wound web material and to the presence and to the characteristics of the winding core, can be useful to facilitate both the learning or self-learning step of the adjustment system 61, and the adjustment operations. For example, the presence of winding cores, a greater winding density of the logs, or a greater diameter of the logs are factors that cause an increase in the frequency of the sharpening cycles. Vice versa, logs with a lower winding density, logs without cores or logs with a smaller diameter means that less frequent sharpening operations are required. All this information is known to the central control unit 19, i.e., to the adjustment system 61 or to the integrated system 62, as it can be communicated by the other machines of the converting line for producing rolls R or other end products. In fact, each product produced by the converting line is characterized by its own “recipe”, i.e., by all the information necessary for the production of the end product.

Based on the examples of adjustment discussed above, those skilled in the art of paper converting machinery, in particular of cutting machines for cutting logs of tissue paper or other cellulose material, may determine a plurality of further adjustment criteria that can be implemented with the described adjustment system 61. In general, with the adjustment system 61 it is possible, through a preliminary learning or self-learning step, to automatically adjust a cutting machine as a function of a plurality of input information relating to the operation of the cutting machine 1, providing in output one or more adjustment commands that act on one or more apparatus, devices, elements or assemblies of the cutting machine, or that are provided to an operator so that they can be implemented on the cutting machine.

1-30. (canceled)

31. A cutting machine for cutting a product made of cellulose material into articles made of cellulose material of smaller longitudinal dimension, comprising:
at least one feed channel of a product to be cut;
members for feeding the product along the at least one feed channel;
at least one cutting blade adapted to cut products into articles according to cutting planes orthogonal to a longitudinal direction of the products;
a sharpening unit adapted to sharpen the cutting blade;
an adjustment system;
wherein the adjustment system is adapted to: receive in input at least one first piece of information on operation of the cutting machine; and to provide, in response to said at least one first piece of information, at least one adjustment command of the cutting machine; and wherein the at least one first piece of information is selected from the group consisting of:
presence of winding cores in the products to be cut;
structure of the winding cores;
winding density of the products;
number of plies forming a web material of the products;
diameter of the winding cores;
diameter of the products;
grammage of plies of paper and/or of strips which form the winding cores;
a parameter correlated to temperature of the at least one cutting blade;
a parameter correlated to mechanical or acoustic vibrations generated during operation;
a parameter correlated to operation of a drive motor of the at least one cutting blade correlated to power absorbed by said drive motor;
a parameter concerning shape of the articles produced by cutting the products.

32. The cutting machine of claim 31, wherein the adjustment system is adapted to: receive in input at least one second piece of information on the operation of the cutting machine, different from the at least one first piece of information, and selected from the group consisting of:
presence of winding cores in the products to be cut;
structure of the winding cores;
winding density of the products;
number of plies forming web material of the products;
diameter of the winding cores;
diameter of the products;
grammage of plies of paper and/or of strips which form the winding cores;
a parameter correlated to temperature of the at least one cutting blade;
a parameter correlated to mechanical or acoustic vibrations generated during operation;
a parameter correlated to the operation of a drive motor of the at least one cutting blade correlated to power absorbed by said drive motor;
a parameter concerning shape of the articles obtained by cutting the products;
a parameter concerning exchange of force between cutting blade and sharpening unit.

33. The cutting machine of claim 31, wherein the at least one adjustment command is automatically transmitted by the adjustment system to a member of the cutting machine.

34. The cutting machine of claim 32, wherein the at least one adjustment command is automatically transmitted by the adjustment system to a member of the cutting machine.

35. The cutting machine of claim 31, further comprising a human-machine interface in data exchange communication with the adjustment system.

36. The cutting machine of claim 34, wherein the at least one adjustment command is sent by the adjustment system to an operator, to be sent to the cutting machine through the human-machine interface.

37. The cutting machine of claim 31, wherein the adjustment system comprises at least one of a self-learning system, and a neural network.

38. The cutting machine of claim 31, wherein the adjustment system associates said at least one first piece of information with each status of the cutting machine.

39. The cutting machine of claim 31, further comprising at least one image acquisition device for acquiring images of the articles obtained from cutting the products; and wherein said at least one first piece of information on the operation of the cutting machine comprises information on a shape of the articles.

40. The cutting machine of claim 39, wherein the information on the shape of the articles comprises information on a profile of the articles at least in a side view or in a front view.

41. The cutting machine of claim 31, wherein said at least one first piece of information on the operation of the cutting machine comprises at least one electrical parameter of at least one drive motor.

42. The cutting machine of claim 41, wherein said at least one drive motor is a drive motor of the cutting blade.

43. The machine of claim 31, wherein the cutting blade is a circular blade; wherein the circular blade is mechanically connected to a rotational motor; and
wherein said at least one first piece of information on the operation of the cutting machine comprises an electrical parameter of said rotational motor.

44. The cutting machine of claim 31, further comprising a vibration detection device for detecting mechanical and/or acoustic vibrations generated by interaction between the at least one cutting blade and the products during cutting; and wherein said at least one first piece of information on the operation of the cutting machine comprises information relating to the mechanical and/or acoustic vibrations detected by the vibration detection device.

45. The cutting machine of claim 31, further comprising a contact force detection device for detecting contact force between the at least one cutting blade and the sharpening unit.

46. The cutting machine of claim 31, further comprising a temperature detection device, adapted to detect a temperature of the at least one cutting blade.

47. The cutting machine of claim 46, wherein the temperature detection device comprises at least one contactless temperature sensor.

48. The cutting machine of claim 46, wherein the temperature detection device is supported by a mobile unit provided with a cyclical forward movement on which the at least one cutting blade is supported.

49. The cutting machine of claim 46, wherein the adjustment system is adapted to modify an operating condition of the cutting machine as a function of detected temperature to reduce operating speed if the detected temperature is above a threshold value.

50. The cutting machine of claim 31, wherein said at least one adjustment command is selected from the group consisting of:
an adjustment command for the sharpening unit;
a start of a sharpening operation of the at least one cutting blade;
a variation of a parameter of the sharpening operation relating to a sharpening time or a sharpening frequency;
a variation of a retaining force on the products during cutting related to lateral retaining elements of the products;
a variation of speed of the at least one cutting blade with respect to the products to be cut related to speed of forward movement of the at least one cutting blade through the products or of cutting speed of the at least one cutting blade;
an operation to replace the at least one cutting blade.

51. The cutting machine of claim 31, wherein the adjustment system is adapted to be set to generate an adjustment command as a function of said at least one first piece of information and of an adjustment mode selectable to give preference to one or other of at least two different operating requirements.

52. The cutting machine of claim 51, wherein the adjustment system is adapted to generate the adjustment command acting on the sharpening unit; wherein the adjustment system is adapted to choose between: a first adjustment mode, with which function of the adjustment command is to optimize the quality of the articles obtained by the cut, and a second adjustment mode, with which the function of the adjustment command is to optimize the life of the at least one cutting blade.

53. The cutting machine of claim 31, wherein the adjustment system is adapted to learn adjustment commands entered by an operator and to associate said adjustment commands with information on operation of the cutting machine.

54. A method for cutting a longitudinally extending product made of web material, into a plurality of articles of smaller longitudinal dimensions, by a cutting machine comprising: at least one feed channel of products to be cut; members for feeding the products along the at least one feed channel; at least one cutting blade adapted to cut the products into articles according to cutting planes orthogonal to a longitudinal extension of the products; a sharpening unit, adapted to sharpen the at least one cutting blade; an adjustment system; wherein the method comprises steps of:
feeding a product to be cut along the feed channel;
moving the at least one cutting blade cyclically with respect to the product to be cut, said at least one cutting blade having a forward movement and a cutting movement with respect to the product;
acquiring at least one first piece of information on operation of the cutting machine;
the adjustment system automatically generating an adjustment command for the cutting machine as a function of said at least one first piece of information on the operation of the cutting machine; wherein said at least one first piece of information on the operation of the cutting machine comprises at least one of the following:
presence of winding cores in products to be cut;
structure of the winding cores;
winding density of the products;
number of plies forming the web material of the products;
diameter of the winding cores;
diameter of the products;
grammage of plies of paper and/or of strips which form the winding cores;
a parameter correlated to temperature of the at least one cutting blade;
a parameter correlated to mechanical or acoustic vibrations generated during operation;
a parameter correlated to operation of a drive motor of the cutting blade correlated to power absorbed by said drive motor;
a parameter concerning shape of the articles obtained by cuttin_{g} the products.

55. The method of claim 54, further comprising acquiring at least one second piece of information on the operation of the cutting machine, different from the at least one first piece of information, and wherein said at least one second piece of information comprises at least one of the following:
the presence of the winding cores in the products to be cut;
the structure of the winding cores;
the winding density of the products;
the number of plies forming the web material of the products;
the diameter of the winding cores;
the diameter of the products;
the grammage Of the plies of paper and/or of the strips which form the winding cores;
a parameter correlated to the temperature of the at least one cutting blade;
a parameter correlated to the mechanical or acoustic vibrations generated during operation;
a parameter correlated to the operation of a drive motor of the at least one cutting blade correlated to the power absorbed by said drive motor;
a parameter concerning the shape of the articles obtained by cutting the products;
a parameter concerning the exchange of force between the at least one cutting blade and the sharpening unit.

56. The method of claim 54, wherein the adjustment command is automatically transmitted by the adjustment system to a member of the cutting machine.

57. The method of claim 55, wherein the adjustment command is automatically transmitted by the adjustment system to a member of the cutting machine.

58. The method of claim 55, wherein the adjustment command is sent by the adjustment system to an operator, to be sent to the cutting machine through a human-machine interface.

59. The method of claim 55, wherein the adjustment system generates the adjustment command on the basis of a preliminary self-learning step.

60. The method of claim 55, wherein the adjustment command acts on the operation of the sharpening unit.

61. The method of claim 60, wherein the adjustment command is selected from the group comprising:
an adjustment command for the sharpening unit;
a start of a sharpening operation of the at least one cutting blade;
a variation of a parameter of the sharpening operation related to a sharpening time or a sharpening frequency;
a variation of a retaining force on the product during cutting related to lateral retaining elements of the products;
a variation of speed of the at least one cutting blade with respect to the products to be cut related to the speed of forward movement of the at least one cutting blade through the product or of the cutting speed of the at least one cutting blade;
an operation to replace the at least one cutting blade.

62. The method of claim 61, wherein the adjustment command of the sharpening unit is selected from the group comprising: a command to start a sharpening cycle of the at least one cutting blade by the sharpening unit; a command to vary at least one sharpening parameter of the sharpening time or the sharpening frequency; a command to request replacement of the sharpening blade.
